(19) United States
(12) Patent Application Publication
(10) Pub. No.: US 2026/0083220 A1
(43) Pub. Date: Mar. 26, 2026

(54) EYEGLASSES HOLDER

(71) Applicant: Juan Machado, Maitland, FL (US)

(72) Inventor: Juan Machado, Maitland, FL (US)

(21) Appl. No.: 19/341,669

(22) Filed: Sep. 26, 2025

Related U.S. Application Data
(60) Provisional application No. 63/699,466, filed on Sep. 26, 2024.

(51) Int. Cl. A45C 11/04; B08B 1/14; B08B 1/30; G02C 13/00

(52) U.S. Cl. CPC A45C 11/043; B08B 1/143; B08B 1/30; G02C 13/006

(57) ABSTRACT

An eyeglasses holder for holding a pair of eyeglasses and for cleaning the pair of eyeglasses having an elongated component with a front side and a rear side. Two sleeves are attached to the front side of the elongated component, each sleeve is configured to hold half of the eyeglasses. Each sleeve is also configured for insertion of one of a thumb and one or more fingers. The elongated component can be bent along a space between the two sleeves to clean the pair of eyeglasses.

### CROSS-REFERENCE TO RELATED APPLICATIONS

This application claims the benefit of U.S. Provisional Application Ser. No. 63/699,466, filed Sep. 26, 2024, said application incorporated herein by reference.

### FIELD OF THE INVENTION

The present invention relates to eyeglasses holders for the protection and cleaning of eyeglasses.

### BACKGROUND OF THE INVENTION

Glasses covers with lens cleaning function is known in the prior art. For example, German Patent No. DE202020005251 and Korean Patent No. 102009177 both disclose a pouch with elastic member lining the opening of the pouch such that the pouch can be stretched to accommodate the entirety of the glasses but snuggly encloses the glasses to prevent them from falling out of the pouch. Both patents disclose that the pouch is made of a cloth material suitable for wiping the lens such that it is not necessary to carry an additional cloth cleaner.

However, the disclosed pouches are not shaped to have dedicated gripping areas when used for the cleaning function. This makes it challenging to manoeuvre the pouch effectively as a cloth to clean the lenses, such as applying the right amount of pressure while preventing the pouch from slipping from the user's hand. It is apparent that the primary function of the glasses cover disclosed in German Patent No. DE202020005251 and Korean Patent No. 102009177 is to protect the glasses, while the cleaning function is merely peripheral.

Glasses covers such as those disclosed in U.S. Pat. No. 6,923,313 and Japanese Patent No. 4011034 are designed to better effect the cleaning function compared to the covers disclosed in German Patent No. DE202020005251 and Korean Patent No. 102009177. U.S. Pat. No. 6,923,313 describes a glasses holder having two pieces of cloths each securely attached to the top and bottom of the holder forming a channel, whereby the lenses are cleaned by sliding the glasses in and out of the channel. Korean Patent No. 102009177 describes a cover, one for each lens, having a two-layer structure with an external harder outer cover and an internal softer cover facing the lenses. Slits are present on the external cover such that fingers can slide between the two layers to maneuver the internal cover to clean the lenses.

However, the disclosed covers in U.S. Pat. No. 6,923,313 and Japanese Patent No. 4011034 are more complex to manufacture than those disclosed in German Patent No. DE202020005251 and Korean Patent No. 102009177.

U.S. patent application Ser. No. 17/858,474 discloses a lens cleaning device that is more effective at cleaning lenses compared to the covers disclosed in German Patent No. DE202020005251 and Korean Patent No. 102009177, while being simpler to manufacture than the covers disclosed in U.S. Pat. No. 6,923,313 and Japanese Patent No. 4011034. The lens cleaning device is an elongated member with a bottom surface and a top surface, where the two distal ends of the bottom surface each comprise a pocket for receiving a thumb or a finger. The elongated member is folded to manipulate the top surface for cleaning lenses once the thumb and the finger is inserted into the pair of pockets. Although it is preferable that the bottom surface of the device is made of high-friction material to allow for better grip by the thumb and the finger, the entire device can be made from a single material.

However, the lens cleaning device disclosed in U.S. patent application Ser. No. 17/858,474 cannot be simultaneously used as a holder for the eyeglasses. Furthermore, only one digit can fit inside each of the pockets of the bottom surface, which may lead to poorer grip and less control over the lens cleaning device.

What is needed therefore is a new eyeglasses holder that is easy to manufacture, is lightweight, is easy-to-use, and can effectively be used as a holder for the eyeglasses and clean the lenses.

### SUMMARY OF THE INVENTION

The general purpose of the present invention is to provide a new eyeglasses holder that also functions as an effective eyeglasses cleaner. The term “eyeglasses” used throughout this document refers to any eyewear having two lenses, which includes but is not limited to sunglasses. The present invention differs from prior art in a number of aspects that will become apparent from the description and the drawings.

One embodiment includes a component having an elongated shape with a front side and a rear side. The front side of the component has two covers, each of which is attached to the opposite ends of the front side to form two sleeves large enough to hold each lens of the eyeglasses. During cleaning, the eyeglasses are taken out of the eyeglasses holder. A user can then insert a thumb into one sleeve and one or more fingers into the other sleeve to fold and maneuver the rear side of the holder to clean the lenses. At least the component of the eyeglasses holder is made of fabric suitable for cleaning lenses. The two covers can be made of the same material as the component, or any other bendable material that will not cause damages such as scratches.

In another embodiment, two holes are left between the edge of where the front side of the component and the pouches attach, to allow for the insertion of temples, which decreases the chances of the glasses falling out of the holder.

### BRIEF DESCRIPTION OF THE DRAWINGS

The drawings show the preferred embodiment.

FIG. 1 is a right side view of the eyeglasses holder.

FIG. 2 is a left side view of the eyeglasses holder.

FIG. 3 is a rear view of the eyeglasses holder.

FIG. 4 is a front view of the eyeglasses holder.

FIG. 5 is an upper perspective view of the eyeglasses holder.

FIG. 6 is a bottom perspective view of the eyeglasses holder.

FIG. 7 is an upper view of the eyeglasses holder.

FIG. 8 is a bottom view of the eyeglasses holder.

FIG. 9 is a side perspective view of the eyeglasses holder when it is bent.

### DETAILED DESCRIPTION OF THE INVENTION

The invention will be described for the purposes of illustration only in connection with certain embodiments; however, it is to be understood that other objects and advantages of the present invention will be made apparent by the following description of the drawings according to the present invention. While a preferred embodiment is disclosed, this is not intended to be limiting. Rather, the general principles set forth herein are considered to be merely illustrative of the scope of the present invention and it is to be further understood that numerous changes may be made without straying from the scope of the present invention.

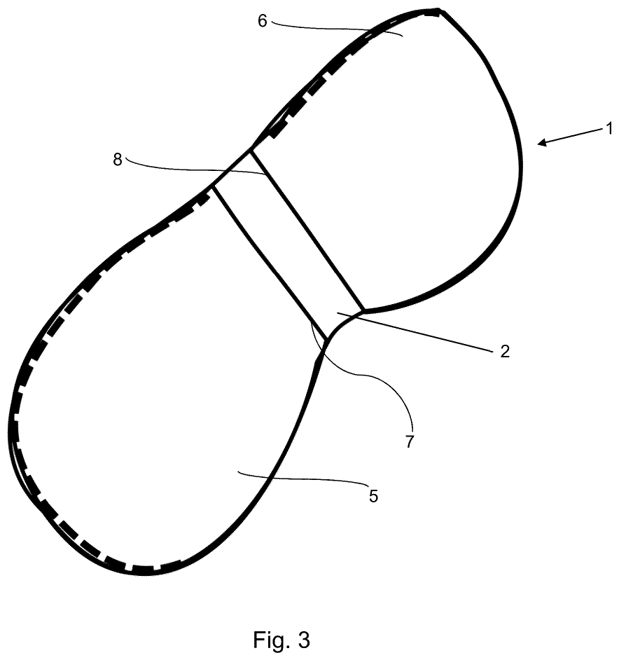

As can be seen in FIG. 3, the eyeglasses holder (1) has a component with a rear side (3). The component has an elongated shape, where the length (L) of the component is at least as long as the frame width of a pair of eyeglasses, and the width (W) of the component is at least as long as the frame height of the pair of glasses.

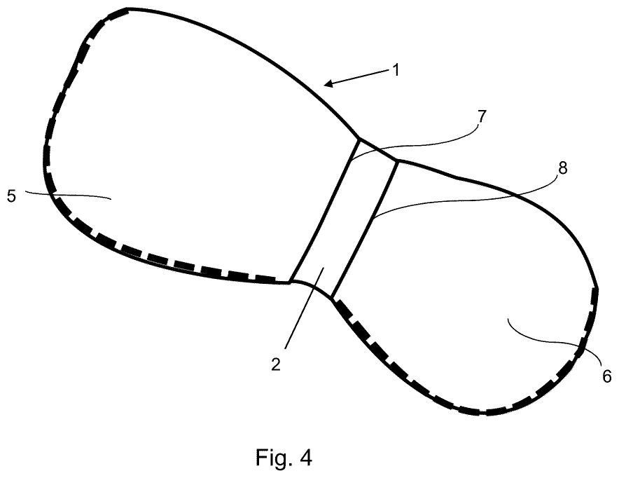

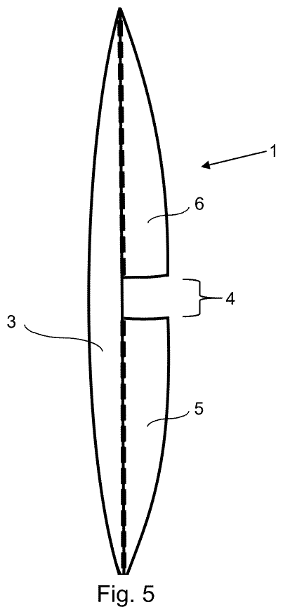

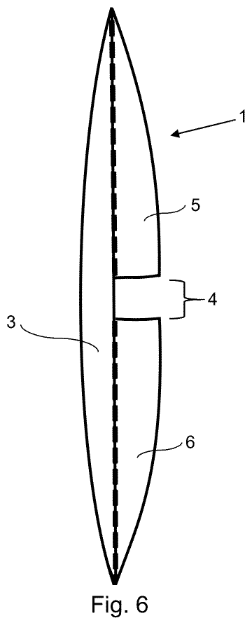

FIGS. 4-6 illustrate the front side (2) of the component of the glasses holder (1) where the pair of eyeglasses is inserted. Two sleeves (5, 6), one for each half of the pair of glasses, are located on the front side (2) of the component of the eyeglasses holder (1). The opening (7, 8) of each sleeve (5, 6) faces each other to allow for insertion of the pair of eyeglasses. The remainder of the edge of the sleeves (5,6) besides the openings (7,8) are preferably sewn onto the front side (2). However, the edge can also be attached to the front side (2) by other methods such as, but is not limited to, using fusible bonding tape, fusible adhesive, fabric glue, and fusible web. To place the pair of eyeglasses into the eyeglasses holder (1), the temples of the pair of eyeglasses are folded, and each half of the pair of eyeglasses is inserted to one of the two sleeves (5,6).

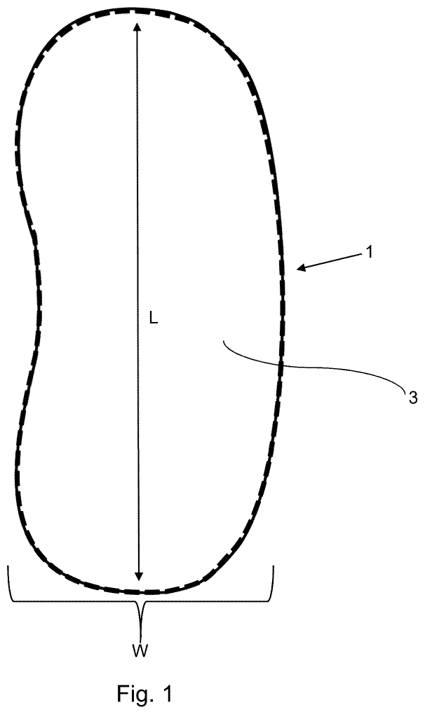

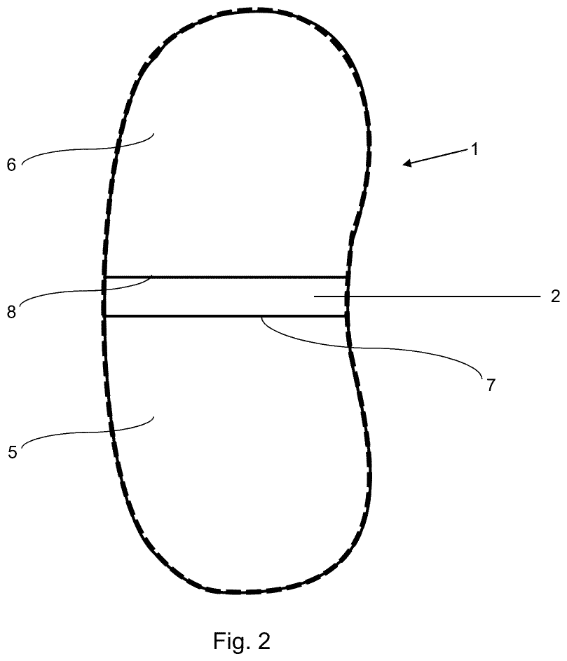

Optionally in an alternative embodiment, and as can be seen especially in FIGS. 1 and 2, each sleeve (5,6) may additionally contain openings (9,10) for insertion of the temples of the pair of eyeglasses. In such cases, the temples are outside of the eyeglasses holder (1). Preferably, the openings (9, 10) are located at the edge of the sleeves (5,6) where the sleeves (5,6) are attached to the front side (3) of the component. This alternative embodiment is especially useful where the frame of the pair of eyeglasses is large like in the case of sunglasses when the sleeves (5,6) are too small to hold the entirety of the eyeglasses including the eyeglasses frame. The exposure of the temples can also allow the user to carry the pair of eyeglasses with the eyeglasses holder (1) in a number of ways, such as but is not limited to hanging one of the temples on a pocket of a piece of clothing when the temple is in a folded formation, or wear the pair of eyeglasses with the eyeglasses holder (1) on the head with both temples in the open formation.

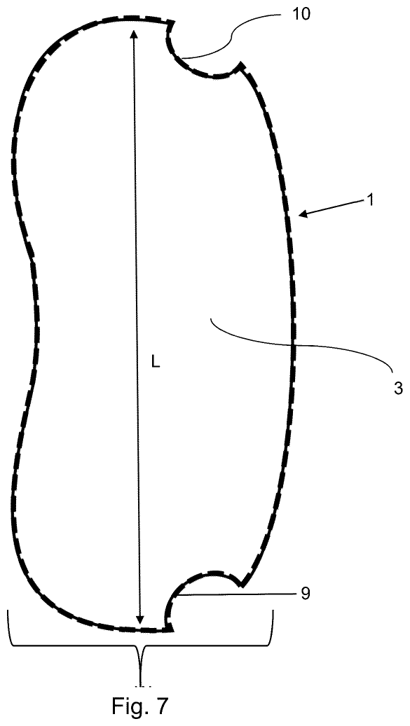

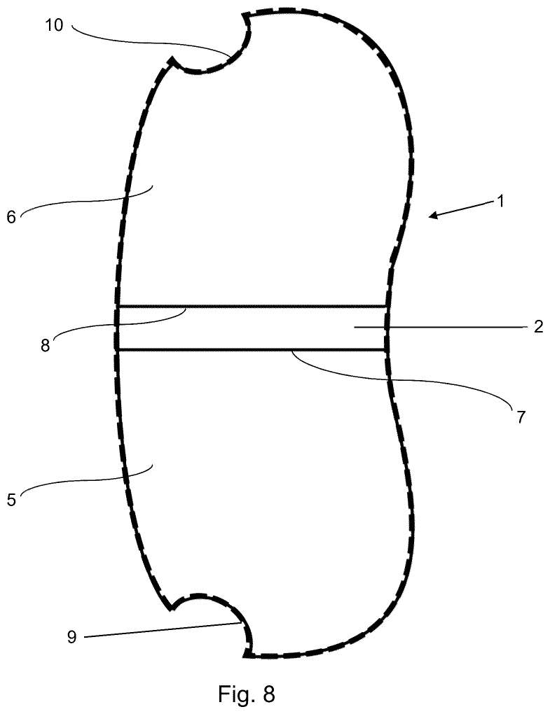

When the eyeglasses holder (1) is used for the cleaning function, the pair of eyeglasses is taken out of the sleeves (5,6). The user's thumb and one or more fingers are inserted into the sleeves (5,6) respectively. Once when the digits are positioned in the sleeves, the eyeglasses holder (1) is preferably bent along the space (4) located between the two sleeves (5,6) by the digits. The space (4) is especially prominently shown in FIGS. 7 and 8.

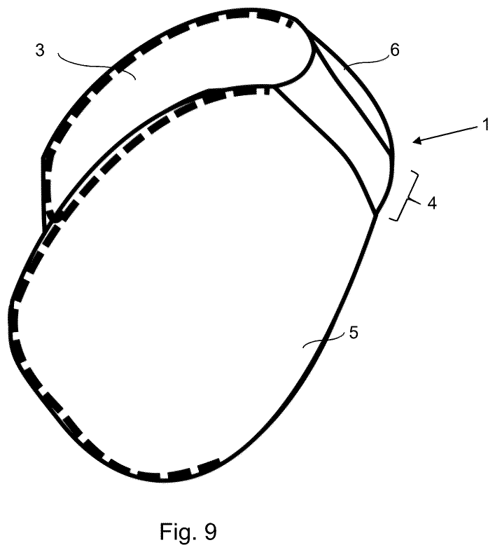

FIG. 9 illustrates the eyeglasses holder (1) in a bent formation, whereby the rear side (3) of the component is bent into two parts. Each part makes contact with opposing sides of the pair of eyeglasses (frame, temple, lens, etc.). The user can then apply pressure to the two parts and rub the glasses from the opposing sides.

The entirety of the eyeglasses holder (1) can be made of a single piece of soft material of any kind that is both flexible to allow for the pair of eyeglasses to be inserted into the sleeves and suitable for cleaning lenses of the glasses without causing any damage, in particular with respect to the lenses. Preferably, the eyeglasses holder (1) is made of microfiber cloth, and in particular coral fleece microfiber cloth. Where different pieces of soft material are used, at least the rear side (3) of the component must be made of one or more soft material that can be used to clean the lenses.

It should be understood that the preferred embodiments mentioned here are merely illustrative of the present invention. Numerous variations in design and use of the present invention may be contemplated in view of the following claims without straying from the intended scope and field of the invention herein disclosed.

1. An eyeglasses holder for holding a pair of eyeglasses of different sizes comprising:
an elongated component having a rear side and a front side;
a first sleeve and a second sleeve each attached to opposite ends of the front side of the elongated component,
wherein the first sleeve and the second sleeve each have an opening that face each other, and
wherein there is a predetermined space located between the first sleeve and the second sleeve;
wherein the elongated component is made of one or more flexible materials such that the elongated component can be bent along the space.

2. The eyeglasses holder of claim 1, wherein the first sleeve and the second sleeve each contain an opening for inserting two temples of the pair of glasses.

3. The eyeglasses holder of claim 1, wherein the first sleeve and the second sleeve each hold half of the eyeglasses, each sleeve having one lens of the pair of eyeglasses.

4. The eyeglasses holder of claim 1, wherein the first sleeve and the second sleeve are each configured to receive one of a thumb and one or more fingers of a user's hand.

5. The eyeglasses holder of claim 1, wherein when the elongated component is bent along the space, the rear side of the elongated component can be used to clean two sides of the pair of eyeglasses simultaneously.
